(19) United States
(12) Patent Application Publication
(10) Pub. No.: US 2021/0082468 A1
(43) Pub. Date: Mar. 18, 2021

(54) DISK DEVICE AND READ PROCESSING METHOD

(71) Applicants: Kabushiki Kaisha Toshiba, Tokyo (JP); Toshiba Electronic Devices & Storage Corporation, Tokyo (JP)

(72) Inventor: Hiroaki Sato, Kawasaki Kanagawa (JP)

(21) Appl. No.: 16/788,715

(22) Filed: Feb. 12, 2020

(30) Foreign Application Priority Data
Sep. 18, 2019 (JP) 2019-169200

(51) Int. Cl. G11B 20/18; G11B 20/10

(52) U.S. Cl. CPC G11B 20/1879; G11B 20/10324; G11B 20/10314

(57) ABSTRACT

According to one embodiment, a disk device includes a disk, a head including a write head which writes data to the disk, a first read head which reads data from the disk, and is configured to detect a first value indicating a signal quality of read data during read processing, and a second read head which reads data from the disk, and is configured to detect a second value indicating a signal quality of read data during read processing, and a controller which determines whether there is a possibility that data cannot be read by the first read head and the second read head based on the first value and the second value.

### CROSS-REFERENCE TO RELATED APPLICATIONS

This application is based upon and claims the benefit of priority from Japanese Patent Application No. 2019-169200, filed Sep. 18, 2019, the entire contents of which are incorporated herein by reference.

### FIELD

Embodiments described herein relate generally to a disk device and a read processing method.

### BACKGROUND

In recent years, a magnetic disk device comprising a head including a plurality of read heads in a two-dimensional magnetic recording (TDMR) system has been developed. For example, the magnetic disk device in a TDMR system can perform a process for synthesizing the signal waveforms of data read by the read heads. If the magnetic disk device in a TDMR system performs this process in a state where at least one of the read heads cannot read data because of a failure, etc., the error rate is increased, and thus, an unrecovered error may occur in a read process.

### BRIEF DESCRIPTION OF THE DRAWINGS

FIG. 1 is a block diagram showing the configuration of a magnetic disk device according to an embodiment.

FIG. 2 is a schematic diagram showing an example of the layout of a head with respect to a disk according to the embodiment.

FIG. 3 is a schematic diagram showing an example of the geometrical layout of a write head and two read heads when the position of the head is determined on a track.

FIG. 4 is a diagram showing an example of the geometrical layout of the write head and the two read heads when the position of the head is determined on a track.

FIG. 5 is a flowchart showing an example of a read processing method according to the embodiment.

### DETAILED DESCRIPTION

In general, according to one embodiment, a disk device comprises a disk; a head comprising: a write head which writes data to the disk; a first read head which reads data from the disk, and is configured to detect a first value indicating a signal quality of read data during read processing; and a second read head which reads data from the disk, and is configured to detect a second value indicating a signal quality of read data during read processing; and a controller which determines whether there is a possibility that data cannot be read by the first read head and the second read head based on the first value and the second value.

Embodiments will be described hereinafter with reference to the accompanying drawings. The drawings are merely examples, and do not limit the scope of the invention.

### Embodiment

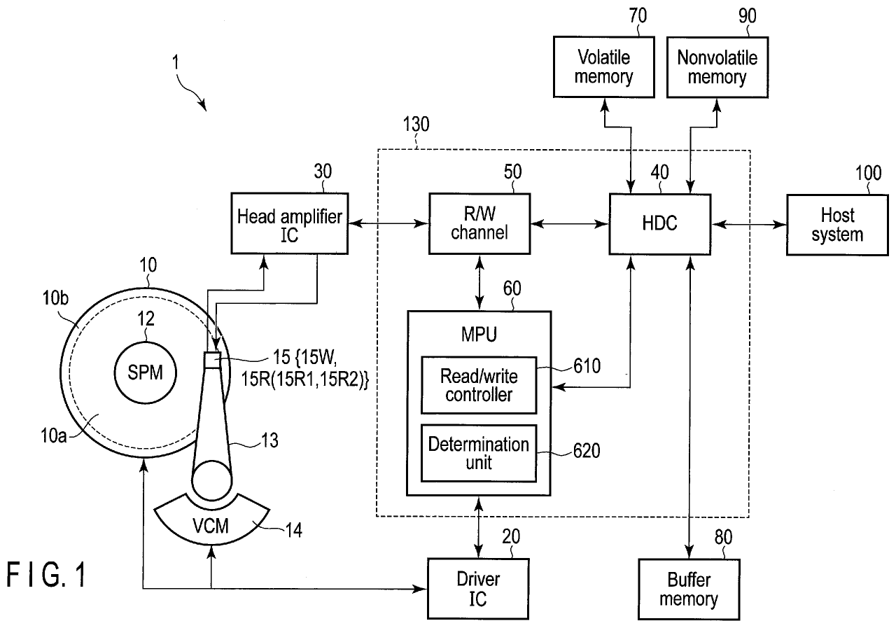

FIG. 1 is a block diagram showing the configuration of a magnetic disk device 1 according to an embodiment.

The magnetic disk device 1 comprises a head disk assembly (HDA) as described later, a driver IC 20, a head amplifier integrated circuit (hereinafter, which may be referred to as a head amplifier IC or a preamplifier) 30, a volatile memory 70, a buffer memory (buffer) 80, a nonvolatile memory 90 and a system controller 130 which is a single-chip integrated circuit. The magnetic disk device 1 is connected to a host system (host) 100. The magnetic disk device 1 is, for example, a magnetic disk device in a two-dimensional magnetic recording (TDMR) system.

The HDA comprises a magnetic disk (hereinafter, referred to as a disk) 10, a spindle motor (SPM) 12, an arm 13 on which a head 15 is mounted, and a voice coil motor (VCM) 14. The disk 10 is attached to the spindle motor 12, and is rotated by driving the spindle motor 12. The arm 13 and the VCM 14 constitute an actuator. The actuator controls movement such that the head 15 mounted on the arm 13 moves to a particular position of the disk 10 by the drive of the VCM 14. Two or more disks 10 and heads 15 may be provided.

In the disk 10, a user data area 10a available to a user and a system area 10b to which information necessary for system management is written are allocated to an area to which data can be written.

Hereinafter, a direction along the circumference of the disk 10 is referred to as a circumferential direction. A direction intersecting with a circumferential direction is referred to as a radial direction. A particular position in a particular circumferential direction of the disk 10 is referred to as a circumferential position. A particular position in a particular radial direction of the disk 10 is referred to as a radial position. A radial position and a circumferential position may be collectively and simply referred to as a position. The disk 10 (specifically, the user data area 10a) is divided into a plurality of areas (hereinafter, which may be referred to as zones) for each particular range in the radial direction. Each zone includes a plurality of tracks (cylinders). Each track includes a plurality of sectors. The term “track” is used to refer to one of the divisional areas in the radial direction of the disk 10, data extending in the circumferential direction of the disk 10 and data written to a track, and used in various other ways. The term “sector” is used to refer to one of the divisional areas in the circumferential direction of a track, data written to a particular position of the disk 10 and data written to a sector, and used in various other ways. The width in the radial direction of a track is referred to as a track width. The center position of a track width at a particular circumferential position of a particular track may be referred to as a track center. Alternatively, the path which passes through the center of a track width in a particular track may be referred to as a track center.

The head 15 comprises a slider as a main body, a write head 15W and a read head 15R. The write head 15W and read head 15R are mounted on the slider. The write head 15W writes data to the disk 10. Read head 15R reads the data recorded in the disk 10. Read head 15R comprises a plurality of read heads, for example, two read heads 15R1 and 15R2. For example, read head 15R1 is provided at a position farthest from the write head 15W. For example, read head 15R2 is provided at a position second farthest from the write head 15W after read head 15R1. In other words, read head 15R2 is located between the write head 15W and read head 15R1. Read head 15R may comprise three or more read heads. Hereinafter, a plurality of read heads 15R, for example, two read heads 15R1 and 15R2, may be collectively referred to as read head 15R. Alternatively, one of a plurality of read heads 15R, for example, one of read heads 15R1 and 15R2, may be simply referred to as read head 15R.

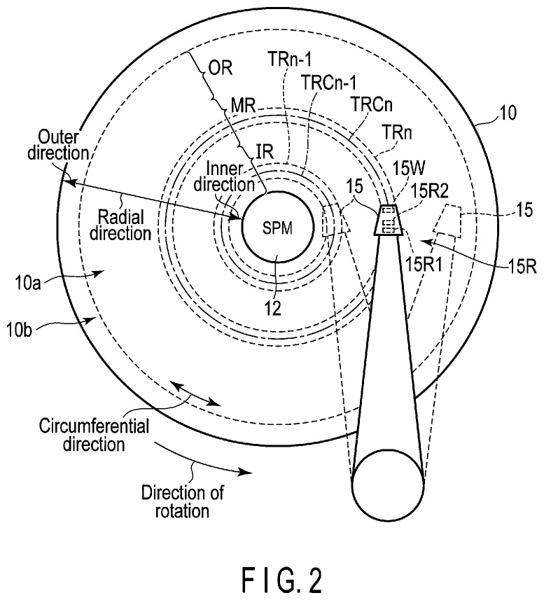

FIG. 2 is a schematic diagram showing an example of the layout of the head 15 with respect to the disk 10 according to the present embodiment. As shown in FIG. 2, the direction of the outer circumference of the disk 10 in the radial direction is referred to as an outer direction (external side), and the opposite direction of the outer direction is referred to as an inner direction (internal side). As shown in FIG. 2, in the circumferential direction, the direction in which the disk 10 rotates is referred to as the direction of rotation. In the example shown in FIG. 2, the direction of rotation is counterclockwise. However, the direction of rotation may be the opposite direction (clockwise). In FIG. 2, the user data area 10a is divided into an inner circumferential region IR located in the inner direction, an outer circumferential region OR located in the outer direction, and a middle circumferential region MR located between the inner circumferential region IR and the outer circumferential region OR. FIG. 2 shows track TRn having track center TRCn, and track TRn-1 having track center TRCn-1. Track TRn-1 is located on the internal side in comparison with track TRn. For example, track TRn may be located in the middle circumferential region MR, and track TRn-1 may be located in the inner circumferential region IR. Track centers TRCn and TRCn-1 are located so as to be concentric with the disk 10. For example, track centers TRCn and TRn-1 are located in the shape of a perfect circle. It should be noted that track center TRCn or TRn-1 may not be circular. They may be located in a wavelike fashion varying in the radial direction of the disk 10.

When the position of the head 15 is determined on track TRn, for example, at track center TRCn, the skew angle is, for example, 0°. The absolute value of the skew angle is increased as the head 15 moves in the outer direction from track center TRCn in the radial direction. The absolute value of the skew angle is increased as the head 15 moves in the inner direction from track center TRCn in the radial direction.

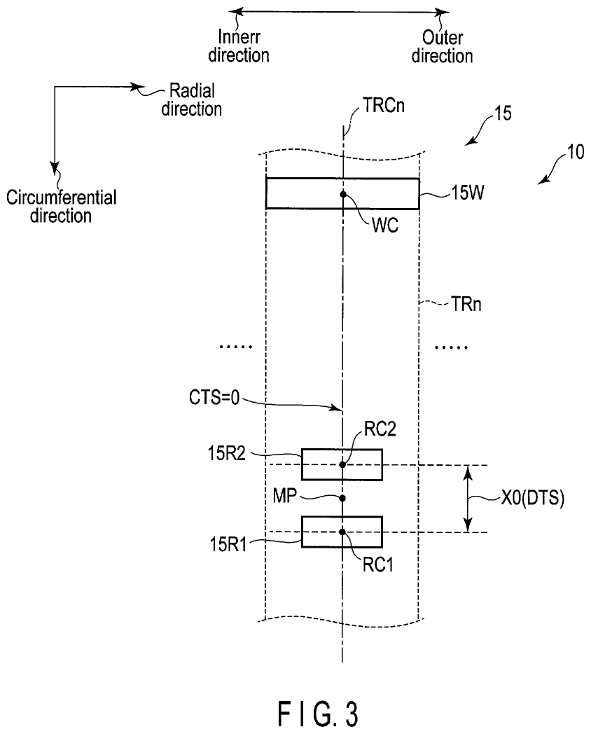

FIG. 3 is a schematic diagram showing an example of the geometrical layout of the write head 15W and two read heads 15R1 and 15R2 when the position of the head 15 is determined on track TRn. FIG. 3 shows center portion WC of the write head 15W, center portion RC1 of read head 15R1, center portion RC2 of read head 15R2, and a middle portion MP located at a middle position between center portion RC1 of read head 15R1 and center portion RC2 of read head 15R2. Hereinafter, the interval in the circumferential direction between center portion RC1 of read head 15R1 and center portion RC2 of read head 15R2 may be referred to as a down track separation (DTS). The interval in the radial direction between center portion RC1 of read head 15R1 and center portion RC2 of read head 15R2 may be referred to as a cross track separation (CTS) or a head separation. Hereinafter, for the sake of convenience for explanation, the center portion of the write head and each portion of the write head may be simply referred to as a write head. The center portion of each read head, the middle portion between two of a plurality of read heads and each portion of each read head may be simply referred to as a read head.

In the example shown in FIG. 3, when the position of the middle portion MP is determined at track center TRCn of track TRn, the head 15 (the write head 15W, read head 15R1, read head 15R2 and the middle portion MP) is arranged in the circumferential direction. In this case, read head 15R1 is not out of alignment with read head 15R2 in the radial direction. In other words, when the position of the middle portion MP is determined at track center TRCn, the CTS is 0. It should be noted that, when the position of the middle portion MP is determined at track center TRCn, read heads 15R1 and 15R2 may be out of alignment in the radial direction, and the write head 15W and read heads 15R1 and 15R2 may be out of alignment in the radial direction.

In the example shown in FIG. 3, when the position of the middle portion MP is determined at track center TRCn, read head 15R1 is spaced apart from read head 15R2 by X0 in the circumferential direction. In other words, when the position of the middle portion MP is determined at track center TRCn, the DTS is X0.

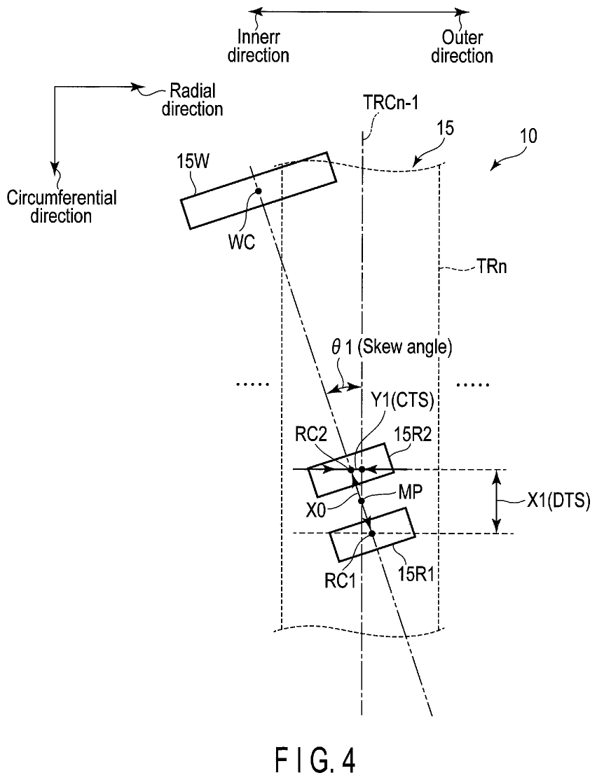

FIG. 4 is a diagram showing an example of the geometrical layout of the write head 15W and two read heads 15R1 and 15R2 when the position of the head 15 is determined on track TRn-1.

In the example shown in FIG. 4, when the position of the middle portion MP is determined at track center TRCn-1 of track TRn-1, the head 15 (the write head 15W, read head 15R1, read head 15R2 and the middle portion MP) is inclined in the inner direction at θ1 with respect to the circumferential direction. In other words, when the position of the middle portion MP is determined at track center TRCn-1, the skew angle is θ1. When the position of the middle portion MP is determined at track center TRCn-1, read head 15R1 is spaced apart from read head 15R2 by CTS=Y1 in the radial direction. In the example shown in FIG. 4, when the position of the middle portion MP is determined at track center TRCn-1, read head 15R1 is spaced apart from read head 15R2 by DTS=X1 in the circumferential direction. Although not shown in the drawings, when the position of the middle portion MP is determined on a particular track located on the external side in comparison with track TRn, the head 15 (the write head 15W, read head 15R1, read head 15R2 and the middle portion MP) is inclined in the outer direction at a particular skew angle.

The driver IC 20 controls the drive of the SPM 12 and the VCM 14 in accordance with the control of the system controller 130 (specifically, an MPU 60 as described later).

The head amplifier IC (preamplifier) 30 comprises a read amplifier and a write driver. The read amplifier amplifies a read signal read from the disk 10 and outputs it to the system controller 130 (specifically, a read/write [R/W] channel 50 as described later). The write driver outputs a write current corresponding to write data output from the R/W channel 50 to the head 15. The head amplifier IC 30 supplies a recording current which excites a recording magnetic field for changing the magnetization direction of the recording bit of the disk 10 to the write head 15W in accordance with the control of the system controller 130, for example, the MPU 60 described later. The head amplifier IC 30 is configured to measure the magnetoresistive resistance (hereinafter, which may be simply referred to as resistance) by supplying current to read head 15R.

The volatile memory 70 is a semiconductor memory in which saved data is lost when the supply of electric power is interrupted. In the volatile memory 70, for example, data necessary for the process of each component of the magnetic disk device 1 is stored. The volatile memory 70 is, for example, a dynamic random access memory (DRAM) or a synchronous dynamic random access memory (SDRAM).

The buffer memory 80 is a semiconductor memory which temporarily records data transferred between the magnetic disk device 1 and the host 100, etc. The buffer memory 80 may be formed integrally with the volatile memory 70. The buffer memory 80 is, for example, a DRAM, a static random access memory (SRAM), an SDRAM, a ferroelectric random access memory (FeRAM) or a magnetoresistive random access memory (MRAM).

The nonvolatile memory 90 is a semiconductor memory which holds saved data even if the supply of electric power is interrupted. The nonvolatile memory 90 is, for example, a NOR or NAND flash read only memory (flash ROM or FROM).

The system controller (controller) 130 is realized by using, for example, a large-scale integrated circuit (LSI) which consists of a plurality of elements on a single chip and is called a system-on-a-chip (SoC). The system controller 130 includes a hard disk controller (HDC) 40, the read/write (R/W) channel 50 and the microprocessor (MPU) 60. The HDC 40, the R/W channel 50 and the MPU 60 are electrically connected to each other. The system controller 130 is electrically connected to, for example, the driver IC 20, the head amplifier IC 60, the volatile memory 70, the buffer memory 80, the nonvolatile memory 90 and the host system 100.

The HDC 40 controls data transfer between the host 100 and the R/W channel 50 in accordance with an instruction from the MPU 60 described later. The HDC 40 is configured to measure an error rate, for example, a sector error rate (SER), in accordance with an instruction from the MPU 60 described later. The HDC 40 is electrically connected to, for example, the volatile memory 70, the buffer memory 80 and the nonvolatile memory 90.

The R/W channel 50 performs the signal process of read data read from the disk 10 and write data to be written to the disk 10 in accordance with an instruction from the MPU 60. The R/W channel 50 comprises a circuit or function for measuring the signal quality of read data. The R/W channel 50 is electrically connected to, for example, the head amplifier IC 30. The R/W channel 50 measures signals and values (hereinafter, which may be referred to as data quality values) related to the signal quality of read data which can be detected during read processing by the head 15 (read head 15R) in real time. In other words, the R/W channel 50 measures data quality values based on read data read by read head 15R in real time. The data quality values include, for example, a DGain value and an Asymmetry value. The DGain value corresponds to the output value of the gain of read data which underwent signal processing in the R/W channel 50. The Asymmetry value is a value indicating the asymmetry property of output amplitude of read data.

The MPU 60 is a main controller which controls each component of the magnetic disk device 1. The MPU 60 controls the VCM 14 via the driver IC 20 and determines the position of the head 15. The MPU 60 controls the operation of writing data to the disk 10 and selects the storage destination of write data transferred from the host 100. The MPU 60 controls the operation of reading data from the disk 10 and controls the process of read data transferred from the disk 10 to the host 100. The MPU 60 is connected to each component of the magnetic disk device 1. The MPU 60 is electrically connected to, for example, the driver IC 20, the HDC 40 and the R/W channel 50.

The MPU 60 includes a read/write controller 610 and a determination unit 620. The MPU 60 performs the process of these components, for example, the read/write controller 610 and the determination unit 620, on firmware. The MPU 60 may comprise these components, for example, the read/write controller 610 and the determination unit 620, as circuits.

The read/write controller 610 controls the read process and write process of data in accordance with a command, etc., from the host 100. The read/write controller 610 controls the VCM 14 via the driver IC 20, determines the position of the head 15 at a particular position on the disk 10, and reads or writes data. For example, when a particular track is read, the read/write controller 610 determines the position of the middle portion MP at a target radial position (hereinafter, referred to as a target position) of the particular track, for example, at the track center, and reads the track by read heads 15R1 and 15R2. When particular data is read by read heads 15R1 and 15R2, the read/write controller 610 performs the process of a signal waveform obtained by synthesizing the signal waveform of read data read by read head 15R1 via the R/W channel 50 and the signal waveform of read data read by read head 15R2 via the R/W channel 50. The read/write controller 610 is also configured to read a particular track by one of read heads 15R1 and 15R2. The read/write controller 610 determines the position of read head 15R1 at a target position of a particular track, for example, at the track center, and reads the track by read head 15R1. When particular data is read by only read head 15R1, the read/write controller 610 performs the process of the signal waveform of read data read by read head 15R1 via the R/W channel 50. The read/write controller 610 determines the position of read head 15R2 at a target position of a particular track, for example, at the track center, and reads the track by read head 15R2. When particular data is read by only read head 15R2, the read/write controller 610 performs the process of the signal waveform of read data read by read head 15R2 via the R/W channel 50. When the magnetic disk device 1 comprises two read heads 15R1 and 15R2, the execution of read processing by two read heads 15R1 and 15R2 may be referred to as a TDMR mode, and the execution of read processing by only one of two read heads 15R1 and 15R2 may be referred to as a single head mode.

The determination unit 620 determines whether or not each read head 15R is a read head (hereinafter, which may be referred to as a defective read head) which cannot read data or cannot normally perform read processing, switches the mode from the TDMR mode to the single head mode, and performs read processing by read head 15R other than at least one defective read head 15R of a plurality of read heads 15R. For example, the determination unit 620 determines whether or not each of read heads 15R1 and 15R2 is a defective read head. When the determination unit 620 determines that read head 15R1 is a defective read head, the determination unit 620 switches the mode from the TDMR mode to the single head mode, for example, switches the setting value of the head amplifier IC 30 from the setting value of the TDMR mode to the setting value of the single head mode, switches the setting value of the R/W channel 50 from the setting value of the TDMR mode to the setting value of the single head mode and switches the setting value of the skew angle from the setting value of the TDMR mode to the setting value of the single head mode, and performs read processing by read head 15R2.

The determination unit 620 may record the setting value of the TDMR mode of the read channel 50 of each read head 15R, the setting value of the single head mode of the read channel 50 of each read head 15R, the setting value of the TDMR mode of the head amplifier IC 30 of each read head 15R, the setting value of the single head mode of the head amplifier IC 30 of each read head 15R, the setting value of the TDMR mode of the skew angle (yew angle) of each read head 15R, the setting value of the single head mode of the head amplifier IC 30 of each read head 15R, the setting value of the single head mode of the skew angle (yew angle) of each read head 15R, etc., in a particular recording area, for example, in the system area 10b or the nonvolatile memory 90.

When a bit (hereinafter, which may be referred to as a determination bit) which corresponds to a function of determining a defective read head is turned on, the determination unit 620 determines whether or not there is a possibility that at least one of read heads 15R is a defective read head based on each data quality value of each read head which can be detected during read processing in the R/W channel 50. The determination unit 620 may record, for example, a determination bit in a particular recording area, for example, in the system area 10b or the nonvolatile memory 90. When the determination unit 620 determines that there is a possibility that at least one read head 15R is a defective read head, the determination unit 620 determines whether or not the at least one read head (hereinafter, which may be referred to as a determination target read head) 15R having the possibility of a detective read head as a result of determination is a defective read head based on a read characteristic value including resistance, an error rate (SER), etc. The read characteristic value corresponds to, for example, a value indicating the characteristics of read processing of read head 15R. As the read characteristic value cannot be detected during read processing, when at least one read head 15R is determined as a determination target read head, the determination unit 620 obtains the read characteristic value of the at least one determination target read head 15R. The determination unit 620 may record the read characteristic value, for example, resistance, an error rate (SER) and the location information of each read head for measuring an error rate, in a particular recording area, for example, in the system area 10b or the nonvolatile memory 90. When at least one determination target read head is determined as a defective read head, the determination unit 620 switches the mode from the TDMR mode to the single head mode and performs read processing by read head 15R other than the at least one detective read head 15R of a plurality of read heads 15R.

For example, the determination unit 620 determines whether at least one of the change rates of a plurality of data quality values of a plurality of read heads, respectively (hereinafter, which may be referred to as data quality change rates), is greater than a threshold (hereinafter, which may be referred to as a quality change rate threshold) or less than or equal to the quality change rate threshold. The data quality change rate corresponds to the ratio (%) of the currently measured data quality value for each read head 15R to the reference value of the data quality value before shipment for each read head 15R. In other words, the data quality change rate corresponds to the ratio (%) of the currently measured data quality value for each read head 15R to the reference value of the data quality value for each read head 15R. The quality change rate threshold is a threshold corresponding to the data quality change rate. The quality change rate threshold is set for, for example, each read head 15R. The determination unit 620 may record the data quality change rate and the quality change rate threshold in a particular recording area for each read head 15R, for example, in the system area 10b, the volatile memory 70 or the nonvolatile memory 90. The determination unit 620 determines that at least one read head 15R in which the data quality change rate is greater than the quality change rate threshold as a result of determination is determination target read head 15R.

For example, the determination unit 620 determines whether the determination bit is turned on or off. When the determination unit 620 determines that the determination bit is turned on, the determination unit 620 determines whether at least one of the change rates of a plurality of DGain values (hereinafter, which may be referred to as DGain change rates) of a plurality of read heads 15R which can be detected during read processing in the R/W channel 50 is greater than a threshold (gain change rate threshold) or less than or equal to the gain change rate threshold. The DGain change rate corresponds to the ratio (%) of the currently measured DGain value for each read head 15R to the reference value of the DGain value before shipment for each read head 15R. In other words, the DGain change rate corresponds to the ratio (%) of the currently measured DGain value for each read head 15R to the reference value of the DGain value before shipment for each read head 15R. The DGain change rate threshold is a threshold corresponding to the DGain change rate. The DGain change rate threshold is set for, for example, each read head 15R. The determination unit 620 may record the DGain change rate and the DGain change rate threshold in a particular recording area for each read head 15R, for example, in the system area 10b, the volatile memory 70 or the nonvolatile memory 90. The determination unit 620 determines that at least one read head 15R in which the DGain change rate is greater than the gain change rate threshold as a result of determination is determination target read head 15R. The determination unit 620 determines whether at least one of the change rates of a plurality of Asymmetry values (hereinafter, referred to as Asymmetry change rates) of a plurality of read heads 15R which can be detected during read processing in the R/W channel 50 is greater than a threshold (hereinafter, which may be referred to as an Asymmetry change rate threshold) or less than or equal to the Asymmetry change rate threshold. The Asymmetry change rate corresponds to the ratio (%) of the currently measured Asymmetry value for each read head 15R to the reference value of the Asymmetry value before shipment for each read head 15R. In other words, the Asymmetry change rate corresponds to the ratio (%) of the currently measured Asymmetry value for each read head 15R to the reference value of the Asymmetry value before shipment for each read head 15R. The Asymmetry change rate threshold is a threshold corresponding to the Asymmetry change rate. The Asymmetry change rate threshold is set for, for example, each read head 15R. The determination unit 620 may record the Asymmetry change rate and the Asymmetry change date threshold in a particular recording area for each read head 15R, for example, in the system area 10b, the volatile memory 70 or the nonvolatile memory 90. The determination unit 620 determines that at least one read head 15R in which the Asymmetry change rate is greater than the Asymmetry change rate threshold as a result of determination is determination target read head 15R.

The determination unit 620 determines whether the change rate of the read characteristic value (hereinafter, which may be referred to as a read characteristic change rate) of at least one determination target read head 15R is greater than a particular threshold (hereinafter, which may be referred to as a characteristic change rate threshold) or less than or equal to the characteristic change rate threshold. The read characteristic change rate corresponds to the ratio (%) of the currently measured read characteristic value for each read head 15R to the reference value of the read characteristic value before shipment for each read head 15R. In other words, the read characteristic change rate corresponds to the ratio (%) of the currently measured data read characteristic value for each read head 15R to the reference value of the read characteristic value for each read head 15R. The characteristic change rate threshold is a threshold corresponding to the read characteristic change rate. The characteristic change rate threshold is set for, for example, each read head 15R. The determination unit 620 may record the read characteristic change rate and the characteristic change rate threshold in a particular recording area for each read head 15R, for example, in the system area 10b, the volatile memory 70 or the nonvolatile memory 90. The determination unit 620 determines that at least one determination target read head 15R in which the read characteristic change rate is greater than the characteristic change rate threshold as a result of determination is a defective read head, switches the mode from the TDMR mode to the single head mode, and performs read processing by read head 15R other than the at least one defective read head 15R of a plurality of read heads 15R.

For example, the determination unit 620 determines whether the change rate of the resistance (hereinafter, which may be referred to as a resistance change rate) of at least one determination target read head 15R is greater than a particular threshold (hereinafter, which may be referred to as a resistance change rate threshold) or less than or equal to the resistance change rate threshold. The resistance change rate corresponds to the ratio (%) of the currently measured resistance for each read head 15R to the reference value of the resistance before shipment for each read head 15R. In other words, the resistance change rate corresponds to the ratio (%) of the currently measured resistance for each read head 15R to the reference value of the resistance before shipment for each read head 15R. The resistance change rate threshold is a threshold corresponding to the resistance change rate. The resistance change rate threshold is set for, for example, each read head 15R. The determination unit 620 may record the resistance change rate and the resistance change rate threshold in a particular recording area for each read head 15R, for example, in the system area 10b, the volatile memory 70 or the nonvolatile memory 90. The determination unit 620 determines that at least one determination target read head 15R in which the resistance change rate is greater than the resistance change rate threshold as a result of determination is a defective read head, switches the mode from the TDMR mode to the single head mode, and performs read processing by read head 15R other than the defective read head of a plurality of read heads. The determination unit 620 determines whether the change rate of an error rate (hereinafter, which may be referred to as an error rate change rate) of determination target read head 15R is greater than a particular threshold (hereinafter, which may be referred to as an error rate change rate threshold) or less than or equal to the error rate change rate threshold. The error rate change rate corresponds to the ratio (%) of the currently measured error rate for each read head 15R to the reference value of the error rate before shipment for each read head 15R. In other words, the error rate change rate corresponds to the ratio (%) of the currently measured error rate for each read head 15R to the reference value of the error rate before shipment for each read head 15R. The error rate change rate threshold is a threshold corresponding to the error rate change rate. The error rate change rate threshold is set for, for example, each read head 15R. The determination unit 620 may record the error rate change rate and the error rate change rate threshold in a particular recording area for each read head 15R, for example, in the system area 10b, the volatile memory 70 or the nonvolatile memory 90. The determination unit 620 determines that at least one determination target read head 15R in which the error rate change rate is greater than the error rate change rate threshold as a result of determination is a defective read head, switches the mode from the TDMR mode to the single head mode, and performs read processing by read head 15R other than the defective read head of a plurality of read heads.

For example, when the determination unit 620 determines that the determination bit is turned on, the determination unit 620 obtains a DGain value corresponding to read head 15R1 and a DGain value corresponding to read head 15R2. The determination unit 620 calculates a DGain change rate corresponding to read head 15R1 based on the DGain value corresponding to read head 15R1, and calculates a DGain change rate corresponding to read head 15R2 based on the DGain value corresponding to read head 15R2. The determination unit 620 determines whether the DGain change rate corresponding to read head 15R1 and the DGain change rate corresponding to read head 15R2 are greater than the gain change rate threshold or less than or equal to the gain change rate threshold. When the determination unit 620 determines that the DGain change rate corresponding to read head 15R1 is greater than the gain change rate threshold, and determines that the DGain change rate corresponding to read head 15R2 is less than or equal to the gain change rate threshold, the determination unit 620 determines that read head 15R1 is determination target read head 15R1. The determination unit 620 determines whether an Asymmetry change rate corresponding to read head 15R1 and an Asymmetry change rate corresponding to read head 15R2 are greater than the Asymmetry change rate threshold or less than or equal to the Asymmetry change rate threshold. When the determination unit 620 determines that the Asymmetry change rate of read head 15R1 is greater than the Asymmetry change rate threshold, and determines that the Asymmetry change rate corresponding to read head 15R2 is less than or equal to the Asymmetry change rate threshold, the determination unit 620 determines that read head 15R1 is determination target read head 15R1.

For example, the determination unit 620 obtains a resistance corresponding to determination target read head 15R1 in which the DGain change rate is greater than the DGain change rate threshold as a result of determination or the Asymmetry change rate is greater than the Asymmetry change rate threshold as a result of determination. For example, the determination unit 620 obtains a resistance corresponding to determination target read head 15R1 in which the DGain change rate is greater than the DGain change rate threshold as a result of determination, and further the Asymmetry change rate is greater than the Asymmetry change rate threshold as a result of determination. The determination unit 620 calculates a resistance change rate corresponding to determination target read head 15R1 based on the resistance corresponding to determination target read head 15R1. The determination unit 620 determines whether the resistance change rate corresponding to determination target read head 15R1 is greater than the resistance change rate threshold or less than or equal to the resistance change rate threshold. The determination unit 620 determines that determination target read head 15R1 in which the resistance change rate corresponding to determination target read head 15R1 is greater than the resistance change rate threshold as a result of determination is a defective read head. When determination target read head 15R1 is determined as a defective read head, the determination unit 620 switches the mode from the TDMR mode to the single head mode, determines the position of read head 15R2 on a particular track, and reads the track by only read head 15R2. In other words, when determination target read head 15R1 is determined as a defective read head, the determination unit 620 executes the single head mode for reading a particular track by only read head 15R2. In the above example, read head 15R1 is a defective read head. When read head 15R2 is a detective read head, the determination unit 620 performs a process in the same way as that when read head 15R1 is a defective read head. In other words, when read head 15R2 is determined as a defective read head, the determination unit 620 executes the single head mode for reading a particular track by only read head 15R1.

For example, when the determination unit 620 determines that the determination bit is turned on, the determination unit 620 obtains a DGain value corresponding to read head 15R1 and a DGain value corresponding to read head 15R2. The determination unit 620 calculates a DGain change rate corresponding to read head 15R1 based on the DGain value corresponding to read head 15R1, and calculates a DGain change rate corresponding to read head 15R2 based on the DGain value corresponding to read head 15R2. The determination unit 620 determines whether the DGain change rate corresponding to read head 15R1 and the DGain change rate of read head 15R2 are greater than the gain change rate threshold or less than or equal to the gain change rate threshold. When the determination unit 620 determines that the DGain change rate corresponding to read head 15R1 is greater than the gain change rate threshold, and determines that the DGain change rate corresponding to read head 15R2 is greater than the gain change rate threshold, the determination unit 620 determines that read heads 15R1 and 15R2 are determination target read heads 15R1 and 15R2. The determination unit 620 determines whether an Asymmetry change rate corresponding to read head 15R1 and an Asymmetry change rate corresponding to read head 15R2 are greater than the Asymmetry change rate threshold or less than or equal to the Asymmetry change rate threshold. When the determination unit 620 determines that the Asymmetry change rate corresponding to read head 15R1 is greater than the Asymmetry change rate threshold, and determines that the Asymmetry change rate corresponding to read head 15R2 is greater than the Asymmetry change rate threshold, the determination unit 620 determines that read heads 15R1 and 15R2 are determination target read heads 15R1 and 15R2.

For example, the determination unit 620 obtains the resistances of determination target read heads 15R1 and 15R2 in which the DGain change rate is greater than the DGain change rate threshold as a result of determination or the Asymmetry change rate is greater than the Asymmetry change rate threshold as a result of determination. For example, the determination unit 620 obtains resistances corresponding to determination target read heads 15R1 and 15R2 in which the DGain change rate is greater than the DGain change rate threshold as a result of determination, and further the Asymmetry change rate is greater than the Asymmetry change rate threshold as a result of determination. The determination unit 620 calculates a resistance change rate corresponding to determination target read head 15R1 based on the resistance corresponding to determination target read head 15R1. The determination unit 620 calculates a resistance change rate corresponding to determination target read head 15R2 based on the resistance corresponding to determination target read head 15R2. The determination unit 620 determines whether the resistance change rate corresponding to determination target read head 15R1 and the resistance change rate corresponding to determination target read head 15R2 are greater than the resistance change rate threshold or less than or equal to the resistance change rate threshold. The determination unit 620 determines that determination target read head 15R1 in which the resistance change rate is greater than the resistance change rate threshold as a result of determination is a defective read head. When determination target read head 15R1 is determined as a defective read head, the determination unit 620 switches the mode from the TDMR mode to the single head mode, determines the position of read head 15R2 on a particular track, and reads the track by only read head 15R2. In other words, when determination target read head 15R1 is determined as a defective read head, the determination unit 620 executes the single head mode for reading a particular track by only read head 15R2. In the above example, read head 15R1 is a defective read head. When read head 15R2 is a detective read head, the determination unit 620 performs a process in the same way as that when read head 15R1 is a defective read head.

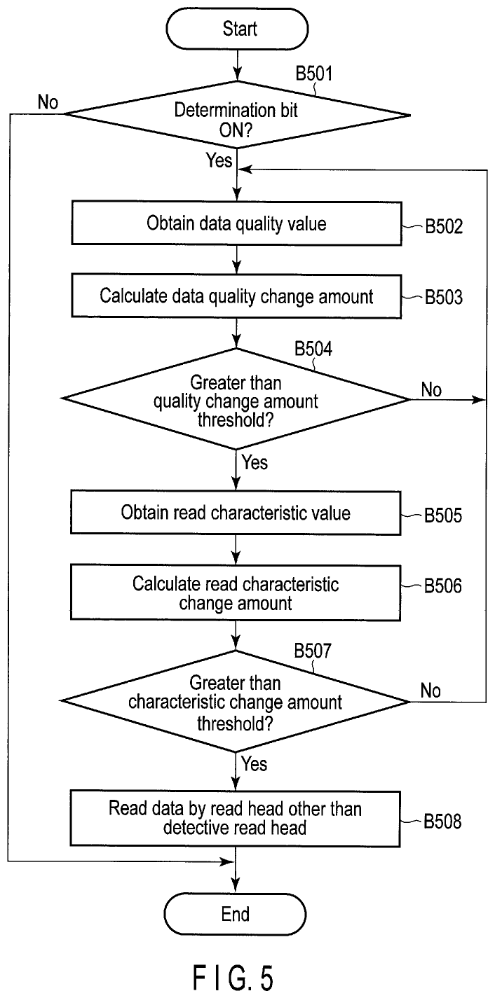

FIG. 5 is a flowchart showing an example of a read processing method according to the present embodiment.

The MPU 60 determines whether or not the determination bit is turned on or off (B501). When the MPU 60 determines that the determination bit is turned off (NO in B501), the MPU 60 terminates the process. When the MPU 60 determines that the determination bit is turned on (YES in B501), the MPU 60 obtains a data quality value corresponding to each read head 15R (B502). For example, the MPU 60 obtains a DGain value and an Asymmetry value corresponding to each read head 15R. The MPU 60 calculates a data quality change rate corresponding to each read head 15R (B503). For example, the MPU 60 calculates a DGain change rate and an Asymmetry change rate corresponding to each read head 15R. The MPU 60 determines whether a data quality change rate corresponding to each read head 15R is greater than the quality change rate threshold or less than or equal to the quality change rate threshold (B504). For example, the MPU 60 determines whether a DGain change rate corresponding to each read head 15R is greater than the DGain change rate threshold or less than or equal to the DGain change rate threshold. The MPU 60 determines whether an Asymmetry change rate corresponding to each read head 15R is greater than the Asymmetry change rate threshold or less than or equal to the Asymmetry change rate threshold. When a data quality change rate corresponding to each read head 15R is less than or equal to the quality change rate threshold (NO in B504), the MPU 60 proceeds to the process of B502. For example, when the MPU 60 determines that a DGain change rate corresponding to each read head 15R is less than or equal to the DGain change rate threshold, and further determines that an Asymmetry change rate corresponding to each read head 15R is less than or equal to the Asymmetry change rate threshold, the MPU 60 proceeds to the process of B502.

When the MPU 60 determines that at least one of a plurality of data quality change rates corresponding to a plurality of read heads 15R, respectively, is greater than the quality change rate threshold (YES in B504), the MPU 60 obtains a read characteristic value corresponding to the at least one determination target read head 15R in which the data quality change rate is greater than the quality change rate threshold as a result of determination (B505). For example, the MPU 60 obtains the resistance of at least one determination target read head 15R in which the DGain change rate is greater than the DGain change rate threshold as a result of determination or the Asymmetry change rate is greater than the Asymmetry change rate threshold as a result of determination. For example, the MPU 60 obtains the resistance of at least one determination target read head 15R in which the DGain change rate is greater than the DGain change rate threshold as a result of determination, and further the Asymmetry change rate is greater than the Asymmetry change rate threshold as a result of determination. For example, the MPU 60 obtains the error rate of at least one determination target read head 15R in which the DGain change rate is greater than the DGain change rate threshold as a result of determination or the Asymmetry change rate is greater than the Asymmetry change rate threshold as a result of determination. For example, the MPU 60 obtains the error rate of at least one determination target read head 15R in which the DGain change rate is greater than the DGain change rate threshold as a result of determination, and further the Asymmetry change rate is greater than the Asymmetry change rate threshold as a result of determination.

The MPU 60 calculates the read characteristic change rate of at least one determination target read head 15R (B506). For example, the MPU 60 obtains the resistance change rate of at least one determination target read head 15R. The MPU 60 obtains an error rate change rate corresponding to at least one determination target read head 15R. The MPU 60 determines whether a read characteristic change rate corresponding to at least one determination target read head 15R is greater than the characteristic change rate threshold or less than or equal to the characteristic change rate threshold (B507). For example, the MPU 60 determines whether a resistance change rate corresponding to at least one determination target read head 15R is greater than the resistance change rate threshold or less than or equal to the resistance change rate threshold. The MPU 60 determines whether an error rate change rate corresponding to at least one determination target read head 15R is greater than the error rate change rate threshold or less than or equal to the error rate change rate threshold. When the MPU 60 determines that a read characteristic change rate corresponding to at least one determination target read head 15R is less than or equal to the characteristic change rate threshold (NO in B507), the MPU 60 proceeds to the process of B502. For example, when the MPU 60 determines that the resistance change rate of each determination target read head 15R is less than or equal to the resistance change rate threshold, and further determines that an error rate change rate corresponding to each determination target read head 15R is less than or equal to the error rate change rate threshold, the MPU 60 proceeds to the process of B502. When the MPU 60 determines that a read characteristic change rate corresponding to at least one determination target read head 15R is greater than the characteristic change rate threshold (YES in B507), the MPU 60 switches the mode from the TDMR mode to the single head mode, reads data by read head 15R other than the detective read head in which the read characteristic change rate is greater than the characteristic change rate threshold as a result of determination, and terminates the process. For example, the MPU 60 switches the mode from the TDMR mode to the single head mode, and reads a particular track by read head 15R other than the detective read head in which the resistance change rate of at least one determination target read head 15R is greater than the resistance change rate threshold as a result of determination or an error rate change rate corresponding to at least one determination target read head 15R is greater than the error rate change rate threshold as a result of determination. For example, the MPU 60 switches the mode from the TDMR mode to the single head mode, and reads a particular track by read head 15R other than the detective read head in which the resistance change rate of at least one determination target read head 15R is greater than the resistance change rate threshold as a result of determination, and further the error rate change rate corresponding to at least one determination target read head 15R is greater than the error rate change rate threshold as a result of determination.

According to the present embodiment, the magnetic disk device 1 comprises a plurality of read heads 15R. The magnetic disk device 1 obtains a DGain value and an Asymmetry value as data quality values. The magnetic disk device 1 calculates the data quality change rate for each read head 15R. The magnetic disk device 1 calculates the DGain change rate and the Asymmetry change rate for each read head 15R. The magnetic disk device 1 determines that a DGain change rate corresponding to each read head is greater than a DGain change rate threshold or less than or equal to the DGain change rate threshold. The magnetic disk device 1 determines whether an Asymmetry change rate corresponding to each read head 15R is greater than an Asymmetry change rate threshold or less than or equal to the Asymmetry change rate threshold. The magnetic disk device 1 obtains the resistance of at least one determination target read head 15R and the error rate change rate of at least one determination target read head 15R. The magnetic disk device 1 determines whether the resistance change rate of each determination target read head 15R is greater than a resistance change rate threshold or less than or equal to the resistance change rate threshold, and determines whether an error rate change rate corresponding to each determination target read head 15R is greater than an error rate change rate threshold or less than or equal to the error rate change rate threshold. The magnetic disk device 1 switches the mode from the TDMR mode to the single head mode, and reads a particular track by read head 15R other than the detective read head in which the resistance change rate of at least one determination target read head 15R is greater than the resistance change rate threshold as a result of determination or an error rate change rate corresponding to at least one determination target read head 15R is greater than the error rate change rate threshold as a result of determination. The magnetic disk device 1 switches the mode from the TDMR mode to the single head mode, and reads a particular track by read head 15R other than the detective read head in which the resistance change rate of at least one determination target read head 15R is greater than the resistance change rate threshold as a result of determination, and further, the error rate change rate of at least one determination target read head 15R is greater than the error rate change rate threshold as a result of determination. In this way, the magnetic disk device 1 can improve the lifetime. Thus, the magnetic disk device 1 can improve the reliability.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a disk;
a head comprising:
a write head which writes data to the disk;
a first read head which reads data from the disk, and is configured to detect a first value indicating a signal quality of read data during read processing; and
a second read head which reads data from the disk, and is configured to detect a second value indicating a signal quality of read data during read processing; and
a controller which determines whether there is a possibility that data cannot be read by the first read head and the second read head based on the first value and the second value.

2. The disk device of claim 1, wherein
when a first change rate corresponding to a ratio of the first value to a first reference value corresponding to the first value is greater than a first threshold corresponding to the first change rate, the controller determines that there is a possibility that data cannot be read by the first read head.

3. The disk device of claim 2, wherein
when a second change rate corresponding to a ratio of the second value to a second reference value corresponding to the second value is greater than a second threshold corresponding to the second change rate, the controller determines that there is a possibility that data cannot be read by the second read head.

4. The disk device of claim 2, wherein
when the controller determines that there is a possibility that data cannot be read by the first read head, the controller determines whether data can be read by the first read head based on a first characteristic value indicating a characteristic of read processing of the first read head which cannot be detected during read processing.

5. The disk device of claim 4, wherein
when a third change rate corresponding to a ratio of the first characteristic value to a third reference value corresponding to the first characteristic value is greater than a third threshold corresponding to the third change rate, the controller determines that data cannot be read by the first read head, and performs read processing by the second read head.

6. The disk device of claim 3, wherein
when the controller determines that there is a possibility that data cannot be read by the first read head and the second read head, the controller determines whether data can be read by the first read head and the second read head based on a first characteristic value indicating a characteristic of read processing of the first read head which cannot be detected during read processing and a second characteristic value indicating a characteristic of read processing of the second read head which cannot be detected during read processing.

7. The disk device of claim 1, wherein
the first value includes a first DGain value corresponding to an output value of a gain of read data read by the first read head and a first Asymmetry value corresponding to an output amplitude asymmetry property of read data read by the first read head, and
the second value includes a second DGain value corresponding to an output value of a gain of read data read by the second read head and a second Asymmetry value corresponding to an output amplitude asymmetry property of read data read by the second read head.

8. The disk device of claim 4, wherein
the first characteristic value includes a resistance of the first read head and an error rate of read data read by the first read head.

9. A disk device comprising:
a disk;
a head comprising a write head which writes data to the disk, and first and second read heads which read data from the disk; and
a controller which determines whether there is a possibility that data cannot be read by the first read head and the second read head based on a first value indicating a signal quality of read data which can be detected during read processing of the first read head and a second value indicating a signal quality of read data which can be detected during read processing of the second read head.

10. The disk device of claim 9, wherein
when a first change rate corresponding to a ratio of the first value to a first reference value corresponding to the first value is greater than a first threshold corresponding to the first change rate, the controller determines that there is a possibility that data cannot be read by the first read head.

11. The disk device of claim 10, wherein
when a second change rate corresponding to a ratio of the second value to a second reference value corresponding to the second value is greater than a second threshold corresponding to the second change rate, the controller determines that there is a possibility that data cannot be read by the second read head.

12. The disk device of claim 9, wherein
the first value includes a first DGain value corresponding to an output value of a gain of read data read by the first read head and a first Asymmetry value corresponding to an output amplitude asymmetry property of read data read by the first read head, and
the second value includes a second DGain value corresponding to an output value of a gain of read data read by the second read head and a second Asymmetry value corresponding to an output amplitude asymmetry property of read data read by the second read head.

13. A read processing method applied to a disk device comprising:
a disk; and
a head comprising:
a write head which writes data to the disk;
a first read head configured to read data from the disk and detect a first value indicating a signal quality of read data during read processing; and
a second read head configured to read data from the disk and detect a second value indicating a signal quality of read data during read processing,
the method comprising
determining whether there is a possibility that data cannot be read by the first read head and the second read head based on the first value and the second value.

14. The read processing method of claim 13, further comprising
determining that there is a possibility that data cannot be read by the first read head when a first change rate corresponding to a ratio of the first value to a first reference value corresponding to the first value is greater than a first threshold corresponding to the first change rate.

15. The read processing method of claim 14, further comprising
determining that there is a possibility that data cannot be read by the second read head when a second change rate corresponding to a ratio of the second value to a second reference value corresponding to the second value is greater than a second threshold corresponding to the second change rate.

16. The read processing method of claim 14, further comprising
determining whether there is a possibility that data cannot be read by the first read head based on a first characteristic value indicating a characteristic of read processing of the first read head which cannot be detected during read processing when it is determined that there is a possibility that data cannot be read by the first read head.

17. The read processing method of claim 16, further comprising
determining that data cannot be read by the first read head and performing read processing by the second read head when a third change rate corresponding to a ratio of the first characteristic value to a third reference value corresponding to the first characteristic is greater than a third threshold corresponding to the third change rate.

18. The read processing method of claim 15, further comprising
determining whether data can be read by the first read head and the second read head based on a first characteristic value indicating a characteristic of read processing of the first read head which cannot be read during read processing and a second characteristic value indicating a characteristic of read processing of the second read head which cannot be detected during read processing when it is determined that there is a possibility that data cannot be read by the first read head and the second read head.

19. The read processing method of claim 13, wherein
the first value includes a first DGain value corresponding to an output value of a gain of read data read by the first read head and a first Asymmetry value corresponding to an output amplitude asymmetry property of read data read by the first read head, and
the second value includes a second DGain value corresponding to an output value of a gain of read data read by the second read head and a second Asymmetry value corresponding to an output amplitude asymmetry property of read data read by the second read head.

20. The read processing method of claim 16, wherein
the first characteristic value includes a resistance of the first read head and an error rate of read data read by the first read head.
